(19) United States
(12) Patent Application Publication
(10) Pub. No.: US 2005/0269172 A1
(43) Pub. Date: Dec. 8, 2005

(54) Disc brake rotors

(76) Inventor: William Anthony Thorpe, Burbage, Leicestershire (GB)

Correspondence Address: Howard & Howard Attorneys, 39400 Woodward Avenue, Suite 101, Bloomfield Hills, MI, 48304-5151, US

(21) Appl. No.: 10/528,590

(22) PCT Filed: Sep. 26, 2003
(86) PCT No.: PCT/GB03/04101

§ 371 Date: Mar. 21, 2005

(30) Foreign Application Priority Data
Oct. 2, 2002 (GB) 0222741.1

(51) Int. Cl. F16D 65/10

(52) U.S. Cl. 188/218 XL; 188/218 R

(57) ABSTRACT

A disc brake rotor (10; 50) comprising a mounting portion (12) and two friction portions (16, 18). One of the friction portions (16) is supported by the mounting portion (12) and the other by vanes (32) extending between the friction portions. Said vanes define cooling ducts (34) the mounting portion (12) also defines a plurality of inlets (42) through which air can pass to said ducts (34). Each inlet (42) is defined by a bounding surface (42a) which includes a section (44; 52) extending between the circumferential extremities (43; 53) of the inlet. Said section (42; 52) faces away from the friction portion (16) supported by the mounting portion (12), said section being continuously curved, symmetrical about an axial centre-line of the inlet, and extending axially less than half its circumferential extent.

### FIELD OF THE INVENTION

This invention is concerned with disc brake rotors.

### BACKGROUND ART

A disc brake rotor is arranged to rotate with a member, such as a wheel of a vehicle or a rotating part of a machine. Such a rotor provides two oppositely-facing annular friction surfaces which, in the operation of the brake, are engaged by blocks of friction material to decelerate the rotor and hence the member. Two friction material blocks are moved (usually by hydraulic means) towards one another into contact with the two friction surfaces so that frictional forces occur slowing the rotation of said rotor, and hence of said member. These frictional forces generate considerable amounts of heat which has to be absorbed by the rotor and causes its temperature to rise. If the rotor becomes too hot, the braking performance is adversely affected and the rotor wears rapidly. Thus, such rotors need to have a significant thermal capacity in order to avoid rapid temperature rises.

In order to reduce temperature rises in disc brake rotors, it is conventional to form the rotor so that it comprises a first generally disc-shaped friction portion which provides one of said friction annular surfaces, and a second generally disc-shaped friction portion which provides the other of said annular friction surfaces. Said first and second portions are of constant thickness and are arranged in spaced parallel relationship. These portions are joined by vanes between which are cooling ducts extending radially outwardly of the rotor. The cooling ducts are arranged so that, as the rotor is rotated, air passes through the ducts and acts to cool said portions of the rotor on their opposite sides to said annular friction surfaces. Entrances to said ducts are provided at an inner edge of said first and second portions and the rotor functions as a centrifugal fan driving air outwardly to exits at the outer edges of said portions.

A conventional disc brake rotor comprises a mounting portion which extends axially between an end thereof which is adapted to be mounted on the hub and an opposite end thereof which supports one of the friction portions of the rotor. The other friction portion is supported by the vanes extending between the friction portions. Most rotors of this type have said other friction portion supported further from the end of the mounting portion which is mounted on the hub than the first mentioned friction portion. This means that there is free access for air to the entrances to the ducts since the space between the two friction portions is clear of the end of the mounting portion. These rotors are categorised as being of the “inboard feed type”.

Rotors of the inboard feed type described above suffer from a problem known as “coning”. This problem is caused by the heat generated by braking causing the friction portions of the rotor to be hotter than the mounting portion thereof. The higher temperature of the friction portion which is supported by the mounting portion causes greater thermal expansion than that of the mounting portion so that, because the rotor portions are off-set from the mounting position on the hub, the junction area between the mounting portion and the friction portion is stressed radially outwardly and the friction portion tends to bend out of the radial plane. This effect is increased by the effect of the thermal expansion of the other friction portion. Thus, the friction surfaces come out of the radial plane into a conical form which results in uneven contact with the brake blocks creating uneven heating and uneven wear.

The problem of coning can be reduced by designing the rotor to be of the “outboard feed type”. In this type of rotor the friction portion which is not directly supported by the mounting portion is arranged to extend around the mounting portion at a position nearer to the mounting position on the hub. This means that instead of enhancing the bending effect of the friction portion which is directly mounted on the mounting portion, the expansion of the vane-supported friction portion acts in the opposite direction and in practice overcomes the effect of the other friction portion, causing coning in the opposite sense but of lesser extent. Thus, the mounting portion is subject to compressive forces due to the coning.

Although rotors of the outboard feed type have a reduced coning effect they suffer from the disadvantage that the mounting portion obstructs the entrances to the air ducts. The air has, therefore to enter through a gap between the inner periphery of the friction portion and the outer periphery of the mounting portion. However, because air has to follow an intricate path to reach the gap, the cooling is compromised. This problem has been addressed in one known rotor design by providing additional inlets in the mounting portion so that additional air can enter the ducts. In this design, these additional inlets have been kept relatively small in order to prevent the mounting portion from being significantly reduced in strength, which is an important factor since this mounting portion must support high torques during braking. The additional inlets are slightly elongated in the circumferential direction so that they have parallel circumferentially extending sides joined at their ends by semi-circular sections. In this known design, the inlets occupy considerably less than half of the circumferential extent of the mounting portion.

The present applicants experimented with a rotor design of the outboard feed type with additional inlets of the type referred to above but of increased size. The objective was to increase the air flow to the ducts and also to reduce the stiffness of the mounting portion thereby enabling it to expand when the friction portion expands, thereby reducing the stress induced during thermal expansion. These experiments revealed that increasing the size of the additional inlets produced a further undesirable effect. It was found that the rotor was subject to large variations of stress around the circumference of the junction area between the mounting portion of the rotor and the friction portion supported thereby. This gave rise to a grave risk of cracking in this area.

The object of the present invention is to provide a rotor in which the problem of coning is reduced, in which the air flow through the ducts is increased, and in which the aforementioned large stress variations are avoided.

### SUMMARY OF THE INVENTION AND ADVANTAGES

The invention provides a disc brake rotor arranged to rotate with a hub about an axis and providing two oppositely-facing annular radially-extending friction surfaces which, in the operation of the brake, are engaged by blocks of friction material to decelerate the rotor and hence the hub, the rotor comprising a mounting portion extending axially between an end thereof which is adapted to be mounted on the hub and an opposite end thereof, the rotor also comprising two friction portions each of which provides one of said annular surfaces the friction portions being arranged in spaced parallel relationship with one of said friction portions being supported by said opposite end of the mounting portion and the other friction portion being positioned so that it extends around the mounting portion and is supported by vanes extending between the friction portions, said vanes also defining cooling ducts, the cooling ducts being arranged so that, as the rotor is rotated, air passes through the ducts and acts to cool the friction portions, the mounting portion also defining a plurality of inlets through which air can pass to said ducts, the inlets being distributed circumferentially around said mounting portion, characterised in that each inlet is defined by a bounding surface which includes a section extending between the circumferential extremities of the inlet, said section facing away from the friction portion supported by the mounting portion, said section being continuously curved, symmetrical about an axial centre-line of the inlet, and extending axially less than half its circumferential extent.

In a disc brake rotor according to the invention, the special shape of the inlets enables the size of the inlets to be increased without jeopardising other aspects of the rotor's performance. Specifically, the shape of the inlets enables stress to be substantially equalised around the circumference of the mounting portion. The use of larger inlets enables greater airflow to be achieved and also gives greater ability for the mounting portion to expand. This increased ability to expand is advantageous since it reduces another form of distortion which is termed “buckling”. Buckling is a wave-like distortion extending around a rotor's friction portion caused by the mounting portion resisting thermal expansion of the friction portion.

The shape of said section of the bounding surface of the inlet is designed to substantially equalise the stress around the circumference of the mounting portion, this stress being essentially in the axial direction. The shape may be an arch-like shape, for example, the shape may be that of half of an ellipse having its major axis aligned circumferentially of the mounting portion.

The remainder of the bounding surface of the inlet is preferably designed to minimise stress also. Preferably, the said remainder is symmetrical about said axial centre-line. Said remainder may be formed by two elliptical sections joined by a section which extends circumferentially or may be formed by an elliptical section such as a half ellipse.

Preferably, in order to increase the air flow, the transverse cross- sectional area of each duct decreases progressively between an entrance to the duct and an intermediate region thereof and increases between said intermediate region and an exit of the duct, the surfaces of the friction portions which bound the ducts extending as convex curves between entrances of the ducts and exits thereof. The variation of said transverse cross-sectional area of the ducts may be achieved by variation in the thickness of said friction portions of the rotor.

It is found that, in a rotor according to the invention, the total extent of said inlets circumferentially may be more than half of the circumferential extent of the mounting portion.

In order to reduce noise created during braking by reducing the possible modes of vibration, the number of inlets may be a prime number greater than or equal to seven. For the same reason, additionally or alternatively the number of vanes is a prime number which is different from the number of inlets and is greater than eleven. It is also desirable if the number of studs by which the rotor is attached to the hub is a prime number. It is also desirable if none of the studs, inlets and vanes are aligned with one another in the radial direction.

### BRIEF DESCRIPTION OF THE DRAWINGS

There now follow detailed descriptions, to be read with reference to the accompanying drawings, of two disc brake rotors which are illustrative of the invention.

FIG. 1 is a prospective view with parts broken away of the first illustrative rotor:

FIG. 2 is a vertical cross-section taken through a portion of the first illustrative rotor:

FIG. 3 is a view on a larger scale than FIG. 1 of an inlet of the first illustrative rotor; and

FIGS. 4 and 5 are views similar to FIGS. 1 and 3, respectively, but of the second illustrative rotor.

### DETAILED DESCRIPTION OF THE PREFERRED EMBODIMENT

The first illustrative disc brake rotor 10 is made of cast iron and is arranged to rotate with a hub (not shown) of a vehicle about an axis 11. The rotor 10 provides two opposite facing annular radially extending friction surfaces 20 and 22. In the operation of the brake, the friction surfaces 20 and 22 are engaged by blocks of friction material (not shown) to decelerate the rotor 10 and hence the hub on which it is mounted.

The rotor 10 comprises a mounting portion 12 which extends axially between an end thereof which is adapted to be mounted on the hub and on opposite end thereof. The first-mentioned end of the portion 12 is formed by an annular plate-like portion 12a. Specifically, the plate-like portion 12a has four holes 14 therein in which studs (not shown) on the hub are received in conventional manner. The mounting portion 12 also comprises a cylindrical portion 12b which projects from the outer periphery of a portion 12a and fits around said hub. The portion 12b extends to said opposite end of the mounting portion 12.

The rotor 10 also comprises two friction portions 16 and 18 which provide the two oppositely-facing annular friction surfaces 20 and 22. The friction portions 16 and 18 are arranged in spaced parallel relationship with the friction portion 16 being supported by said opposite end of the mounting portion 12. Specifically, the mounting portion 12 makes an annular junction with the friction portion 16. The portions 12,16 and 18 of the rotor 10 are integrally cast out of grey cast iron.

The friction portion 18 is positioned axially nearer to the plate-like portion 12a of the mounting portion 12 than the friction portion 16. The friction portion 18 extends around the portion 12b and is supported by vanes 32 which extend between the two friction portions 16 and 18, there being an annular gap 31 between the inner periphery of the friction portion 18 and the portion 12b of the mounting portion. The vanes 32 are integrally cast with the portions 12,16 and 18.

The portion 16 is shaped generally as an annular plate bounded at it inner edge by its connection with the cylindrical portion 12b, and at its outer edge by an axially-extending cylindrical surface 24. The portion 16 is also bounded by the friction surface 20, which is planar and extends radially, and by a convex surface 26. Because of the curvature of the surface 26, the portion 16 is at its thickest at a radially intermediate region thereof and is of lesser thickness adjacent to its inner and outer edges. The portion 18 is bounded at its outer edge by an axially-extending cylindrical surface 28 which has the same radius as the surface 24. The portion 18 is also bounded by the friction surface 22 which is planar and extends radially, facing in the opposite direction to the surface 20. The portion 18 is also bounded by a convex surface 30 which is similar to the surface 26 which it faces except that, at its radial inner edge, the surface 30 bounds an annular gap 31 between the cylindrical portion 12b and the friction portion 18.

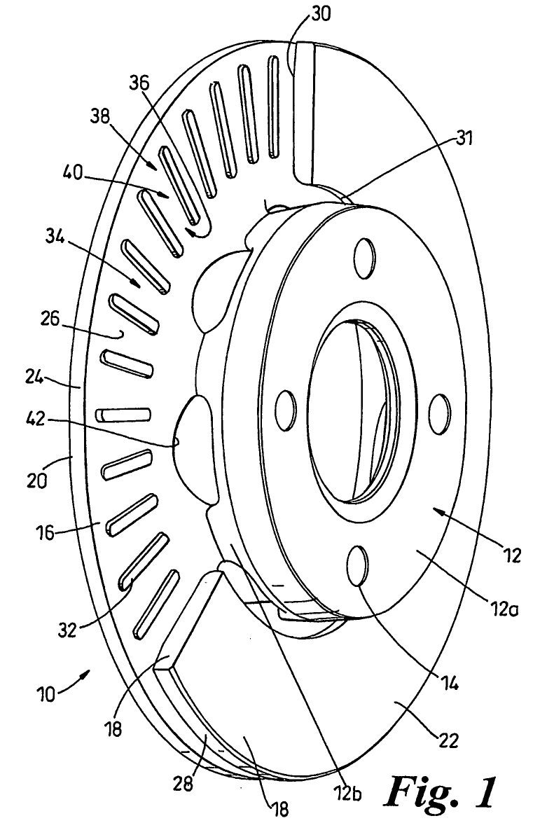

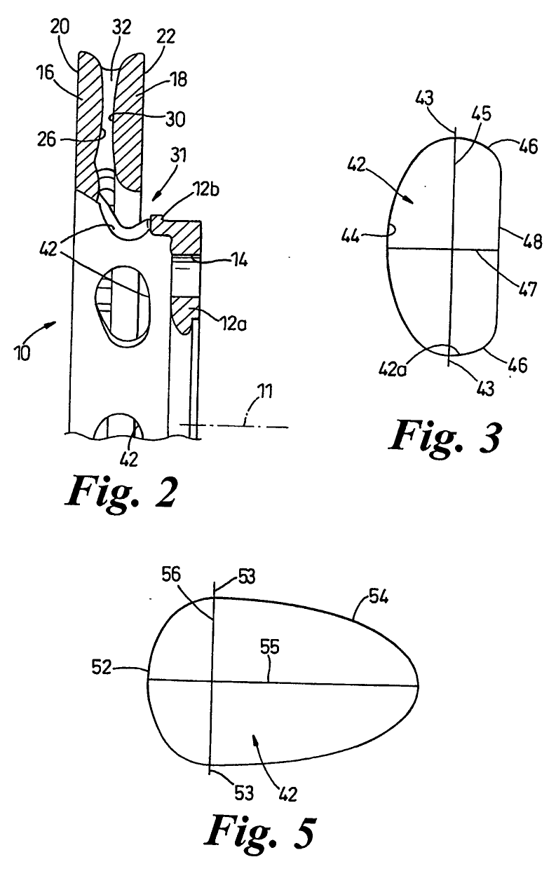

The vanes 32 also define cooling ducts 34 which extend radially outwardly and are arranged so that, as the rotor is rotated, air passes through the ducts 34 and acts to cool the friction portions 16 and 18. In FIG. 1, the vanes 32 which are visible have been sliced through in a plane normal to the axis about which the rotor 10 rotates so that only the junctions between the vanes 32 and the portion 16 are visible. The vanes 32 serve to support the portion 18 (only part of the portion 18 is shown in FIG. 1). The vanes 32 project from the surfaces 26 and 30 at equal circumferential intervals, there being thirty-seven such vanes 32. The ducts have entrances 36 bounded by the inner edges of two adjacent vanes 32, and by the surfaces 26 and 30. The ducts have exits 38 between the outer edges of the vanes 32. Between its entrances 36 and its exit 38, each duct 34 is bounded by two adjacent vanes 32 and by portions of the surfaces 26 and 30.

At any point along its length, the transverse cross-sectional area of a duct 34 depends on the spacing of the adjacent vanes 32 and on the spacing of the surfaces 26 and 30. A controlled variation of this transverse cross-sectional area of the duct 34 is achieved by the variation in the thickness of said friction portions 16 and 18 of the rotor caused by the convexity of the surfaces 26 and 30. Even though the vanes 32 get progressively further apart with increasing radius, the convexity of the surfaces 26 and 30 is such that the transverse cross-sectional area of each duct 34 decreases progressively between its entrance 36 and an intermediate region 40 of the duct 34 where the surfaces 26 and 30 have their closest approach. The intermediate region 40 is substantially opposite the radial centre of the friction surfaces 20 and 22. The transverse cross-sectional area of the duct 34 increases between said intermediate region 40 and the exit 38 of the duct 34.

In the operation of the first illustrative rotor 10, rotation of the rotor causes air to enter the gap 31 between the cylindrical portion 12b and the friction portion 18. The gap 31 therefore acts to allow air to pass to the entrances 36 of the ducts 34. In order to improve the air flow through the ducts 34, and therefore the cooling of the rotor 10, the mounting portion 12 also defines seven inlets 42 through which air can pass to said ducts 34. The inlets 42 are provided in the cylindrical portion 12b in the area thereof which are aligned in the same radial plane as the friction portion 18 but extend axially opposite the entrances 36 of the ducts 34. These inlets 42 are in the form of holes through the portion 12b and are equally distributed circumferentially around the portion 12b.

The inlets 42 have a special shape which is shown in FIG. 3. Each inlet 42 is defined by a bounding surface 42a. The bounding surface 42a includes a section 44 which extends between the two circumferential extremites 43 of the inlet 42. The section 44 faces away from the friction portion 16 which is supported by the mounting portion 12. As can be seen from FIG. 3, the section 44 is continuously curved, is symmetrical about an axial-centre line 47 of the inlet 42, and extends axially less than half its circumferential extent, ie the length of a line 45 joining the circumferential extremities 43 is more than twice as long as the line 47 joining the section 44 to the line 45.

The remainder of the shape of each inlet 42 is defined by further sections of the bounding surface 42a. Specifically, these sections are a straight section 48 which extends circumferentially of the rotor 10 and two sections 46 which join the extremities 43 to the ends of the section 48. These sections 46 are each in the form of a quarter of an ellipse.

The air entering the gap 31 and the inlets 42 is accelerated by centrifugal force along the ducts 34 until it reaches the intermediate region 40 of the duct, where the transverse cross-sectional area of the duct reaches its minimum. This acceleration is caused by the decreasing transverse cross-sectional area of the duct 34. At the intermediate region 40, which is arranged to be directly opposite to the points at which the blocks of friction material engage the surfaces 20 and 22, the air reaches its maximum velocity, thereby increasing the cooling efficiency in this region. After passing through the intermediate region 40, the air decelerates until it passes out through the exits 38 of the ducts 34.

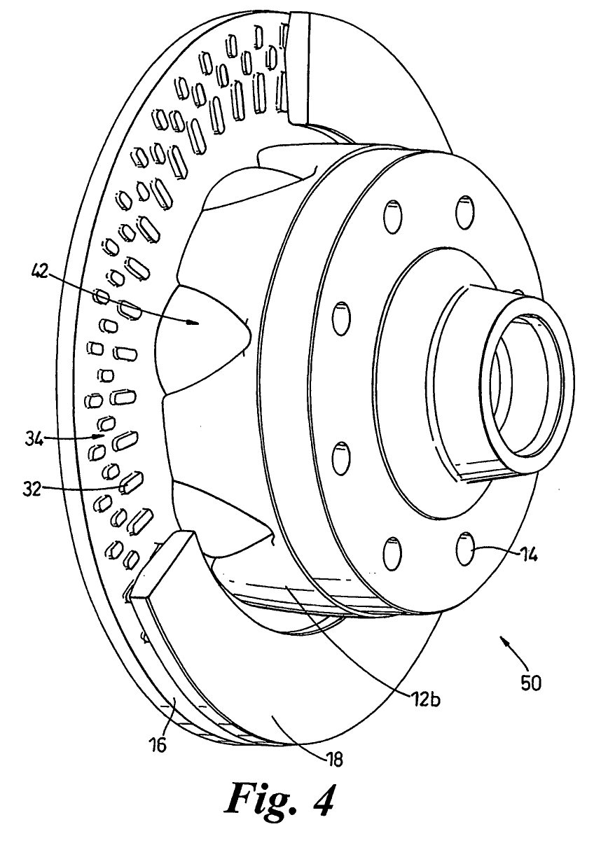

The second illustrative disc brake rotor 50 is shown in FIGS. 4 and 5. The rotor 50 is similar to the rotor 10 and like parts thereof are given the same reference numerals. The rotor 50 differs from the rotor 10 in that the portion 12b extends further axially than that of the rotor 10, in that the portion 12a has eight holes 14, in that the vanes 32 are arranged differently, and in the shape of the inlets 42.

In the rotor 50, the vanes 32 are arranged in three concentric rows with a centre row off-set from the other two rows circumferentially. This is advantageous as it reduces stress induced by one of the friction portions 16 or 18 expanding further than the other.

The shape of the inlets 42 of the rotor 50 is illustrated in FIG. 5. In this case, the bounding surface 42a has two sections 52 and 54. The section 52 faces away from the friction portion 16, is continuously curved, is symmetrical about the axial centre line 55 of the inlet, extends between the circumferential extremities 53 of the inlet, and extends axially less than half of the circumferential extent of the inlet. Specifically, the section 52 is in the shape of a half ellipse with its major axis on the line 56 joining the extremities 53. The section 54 joins the section 52 at the extremities 53 and is in the shape of a half ellipse with its major axis on the line 55 and its minor axis on the line 56.

1 A disc brake rotor arranged to rotate with a hub about an axis and providing two oppositely-facing annular radially-extending friction surfaces which, in the operation of the brake, are engaged by blocks of friction material to decelerate the rotor and hence the hub, the rotor comprising a mounting portion extending axially between an end thereof which is adapted to be mounted on the hub and an opposite end thereof, the rotor also comprising two friction portions each of which provides one of said annular surfaces the friction portions being arranged in spaced parallel relationship with one of said friction portions being supported by said opposite end of the mounting portion and the other friction portion being positioned so that it extends around the mounting portion and is supported by vanes extending between the friction portions, said vanes also defining cooling ducts and entrances to said ducts, the cooling ducts being arranged so that, as the rotor is rotated, air passes through the ducts and acts to cool the friction portions, the mounting portion also defining a plurality of inlets through which air can pass to said ducts, the inlets being distributed circumferentially around said mounting portion, characterised in that each inlet is defined by a bounding surface which includes a section extending between the circumferential extremities of the inlet, said section facing away from the friction portion supported by the mounting portion, said section being continuously curved, symmetrical about an axial centre-line of the inlet, and extending axially less than half its circumferential extent, the inlet extending axially opposite to the entrances of said cooling ducts between the friction portions.

2 A disc brake rotor according to claim 1 characterised in that said section of the bounding surface of the inlet has an arch-like shape.

3 A disc brake rotor according to either one of claims 1 or 2 characterised in that said section of the bounding surface of the inlet has a shape which is that of half of an ellipse having its major axis aligned circumferentially of the mounting portion.

4 A disc brake rotor according to any one of claims 1 to 3, characterised in that the remainder of the bounding surface of the inlet is symmetrical about said axial centre-line, and is formed by two elliptical sections joined by a section which extends circumferentially.

5 A disc brake rotor according to any one of claims 1 to 3, characterised in that the remainder of the bounding surface of the inlet is symmetrical about said axial centre-line, and is formed by an elliptical section.

6 A disc brake rotor according to any one of claims 1 to 5, characterised in that the transverse cross-sectional area of each duct decreases progressively between an entrance to the duct and an intermediate region thereof and increases between said intermediate region and an exit of the duct, the surfaces of the friction portions which bound the ducts extending as convex curves between entrances of the ducts and exits thereof.

7 A disc brake rotor according to claim 6, characterised in that the variation of said transverse cross-sectional area of the ducts is achieved by variation in the thickness of said friction portions of the rotor.

8 A disc brake rotor according to any one of claims 1 to 7, characterised in that the total extent of said inlets circumferentially is more than half of the circumferential extent of the mounting portion.

9 A disc brake rotor according to any one of claims 1 to 8, characterised in that the number of inlets is a prime number greater than or equal to seven.

10 A disc brake rotor according to any one of claims 1 to 9, characterised in that the number of vanes is a prime number which is different from the number of inlets and is greater than eleven.

11 A disc brake rotor according to any one of claims 1 to 10 in which the mounting portion is flared in a radially outward direction at said opposite end supporting said one friction portion and characterised in that said section of the boundary surface of each said inlet is radially closer to said duct entrances than the remainder of the boundary surface.
